(19) United States
(12) Patent Application Publication
(10) Pub. No.: US 2007/0051522 A1
(43) Pub. Date: Mar. 8, 2007

(54) Sprinkler head assembly

(76) Inventor: Vincenzo Chiuchiolo, Revere, MA (US)

Correspondence Address: CESARI AND MCKENNA, LLP, 88 BLACK FALCON AVENUE, BOSTON, MA, 02210, US

(21) Appl. No.: 11/210,318

(22) Filed: Aug. 24, 2005

(51) Int. Cl. A62C 35/00; A62C 37/08

(52) U.S. Cl. 169/37; 169/16

(57) ABSTRACT

A sprinkler head assembly includes a sprinkler head coupling with an interioraly threaded axial passage, an annular shelf surrounding an end of the passage and a sleeve surrounding the shelf and extending an appreciable distance perpendicular thereto. The assembly also includes a sprinkler head having an externally threaded tubular neck that is threadedly engaged in the coupling passage. The neck has a base which defines a valve seat in which a movable valve member is releasably retained by a heat responsive member. The coupling and neck are designed and dimensioned so that when the neck is threaded into the coupling, a dam is present at the inner edge of the shelf that isolates the shelf from the interior of the neck and the valve member thereby preventing any fire protection cement from reaching the valve member in the coupling.

This application relates to an improved high pressure sprinkler head assembly especially for use in commercial and residential buildings.

### BACKGROUND OF THE INVENTION

Most states have fire codes that require high pressure sprinkler heads in the ceilings of building spaces. Typically the heads are spaced apart about eight to ten feet in a rectangular grid which spans the area of the ceiling.

Water is delivered to the sprinkler heads by means of piping connected to a water source which delivers water under a relatively high pressure in excess of 100 psi. In present day commercial and residential structures, the high pressure piping is usually of plastic with the pipe runs being connected to each other by plastic fittings such as couplings, Ts, elbows, etc. To assure fluid tight connections, a plastic cement is applied to the opposing surfaces of the pipes and fittings at each connection. The cement used for the high pressure plastic plumbing of this type tends to be non-viscous and rather runny.

Referring to FIG. 1, when installing a typical sprinkler system, various pipe runs 10 are secured via brackets or straps 12 to wood or metal joists or studs 14. In some commercial buildings, the pipe runs may be secured to a slab which forms both the ceiling of a lower space and the floor of an upper space in the building. The pipes 10 in the system are connected end to end by standard fittings such as T fittings 16 and elbows 18. A conventional high pressure plastic cement A (FIG. 2) is applied at all of the joints between the pipes 10 and the fittings. A pipe 10a at the beginning of a run is connected to a high pressure water source (not shown). Another pipe at the end of a run such as the one shown at the right side of FIG. 1 may be closed by an end cap 22. Typically, the Ts 16 are located along the pipe runs so that they are directly above the planned locations of the system's sprinkler heads one such head being indicated generally at 26. As shown in FIG. 1, the depending leg 16a of each T 16 in the sprinkler system is connected to a vertical pipe stub 32 which is terminated by a standard sprinkler head reducer coupling 34.

In order to conceal the aforesaid rough plumbing, a drop ceiling 35 is provided which includes the usual stringers 36 which are arranged in a horizontal grid and suspended from the studs 14 by hangers 37. The stringers support and join the ceiling panels 35a that make up the ceiling 35. A clearance hole 38 is provided in ceiling 35 to accommodate each sprinkler head 26.

Refer now to FIG. 2 which shows the standard reducer coupling 34 and conventional sprinkler head 26 in greater detail. The coupling comprises a metal bushing 52 having an enlarged head 52a and a smaller diameter shank 52b both of which form an axial passage 52c which is threaded at a passage segment 52d in the shank. The coupling also includes a deep plastic sleeve 54 which surrounds the bushing head 52a. Usually formed integrally with the sleeve is an annular shelf 54a which covers head 52a and a radially inwardly extending flange 54b extending under the edge of the head, both of which serve to lock the sleeve to the bushing and provide a fluid tight seal between the two. The shelf 54a also provides a seat for the lower end of the pipe stub 32. In those couplings where the plastic shelf 54a is not present, the top of the bushing 52 itself may constitute the shelf.

The threaded segment 52d of passage 52c is adapted to threadedly receive an exteriorally threaded tubular neck 26a of the sprinkler head 26. As shown in FIG. 2, when installed, neck 26a extends only into the threaded segment 52d of passage 52c. Therefore, the upper end of the neck is normally well below the top of bushing 52 and shelf 54a.

Sprinkler head 26 is a standard sprinkler head which invariably also includes a base 26b at the lower end of neck 26a which defines an axial passage 26c whose lower end forms an annular seat S similar to a valve seat. The passage is normally closed by a closure member or plug 26d which is slidably received in that passage and seats against the seat S. A U-shaped saddle 26e extends down from base 26b and a rigid, thin glass ampoule 26f is captured between that saddle and the lower end of closure member 26d, thereby holding the member against the seats so that no water flows from the sprinkler head 26. That ampoule 26f is filled with a volatile fluid, which, when heated by a fire in the space below ceiling 35, expands and breaks the ampoule. In that event, the closure member 26d is pushed out of the passage 26c by the pressure of the water delivered to the sprinkler head 26 so that water sprays into that space and helps to dowse the fire.

When installing a sprinkler system, after the plumping has been roughed in with the Ts 16 in the planned positions in the system layout, the proper practice is to install plumbing drops to the planned locations of the sprinkler heads, cutting the pipe stubs 32 to length so that when the couplings 34 are attached to the stubs and the latter are joined to the Ts, the undersides of the couplings 34 will be located just above the planned level of the drop ceiling 35. It should be understood that the stub lengths may vary depending upon the distance between the joists 14 and the ceiling 35.

It is important to appreciate also that the system plumbing and the ceiling 35 are usually installed by different work crews having different work schedules. Therefore in some cases, the pipe stubs 32 and their couplings 34 are installed before the stringers 36 and in some cases, after the stringers. In the latter event, the vertical plumbing drops from some Ts 16 may have to be modified because those Ts wind up directly above an already installed ceiling stringer 36. In other words, the connections between those Ts and the corresponding couplings 34 have to be made up specially using combinations of pipe stubs and elbows to jog around the obstructing stringers. All of these plumbing connections or joints require a generous application of high pressure cement A which is runny as noted above. After the drops have been installed, the proper practice is to screw the sprinkler heads 26 into the couplings 34. This is usually done before the ceiling panels 35a have been installed, but may be done after, depending upon work crew scheduling.

In any event, what often happens is the workers do not follow the proper procedures. On the contrary, to save time, they join couplings 34 to the ends of cut-to-length pipe stubs 32 or jogged equivalents, using cement A and screw sprinkler heads into those couplings using a special jig at the job site. Then, they apply cement to the upper ends of the stubs and the interiors of the associated T legs 16a and insert the aforesaid assemblies into the T legs. The result is that in many cases, the cement A tends to run down the inside wall of any vertically oriented stub 32, or coupling 34 and into the associated sprinkler head 26. More particularly, as shown in FIG. 2, cement A runs down inside sleeve 54 and over the shelf 54a and down the wall of passage 52c and down into the neck 26a of sprinkler head 26. From there, the cement A flows onto base 26b of the sprinkler head and accumulates around the closure member or plug 26d where it eventually solidifies as shown thereby freezing up the closure member.

The same thing may happen if a pipe 10 is capped by a cap 22 close to a T 16 as shown in FIG. 1; i.e. cement A from the end cap joint may run down into a sprinkler head via the plumping drop from that T.

Resultantly, when the ampoule 26f of head 26 breaks in response to excessive heat at that sprinkler head, the closure member or plug 26d is unable to move from its seated position shown in FIG. 2, making the sprinkler head inoperative. It should be borne in mind that a given sprinkler head may sit for years after installation before it is called upon to activate in response to a fire in the associated building space. Therefore, a building occupant may never know that one or more of the sprinkler heads in the building space may be inoperative. In other words, even though the overall sprinkler system may be pressure tested periodically, the individual sprinkler heads are seldom tested for operability. Therefore, a sprinkler system with sprinkler heads installed improperly as just described can present a serious and hidden safety hazard.

### SUMMARY OF THE INVENTION

Accordingly, it is an object of the present invention to provide an improved sprinkler head assembly which isolates the sprinkler head from pipe cement applied during installation of the sprinkler system.

Another object of the invention is to provide such an assembly which prevents pipe cement from interfering with the proper operation of the sprinkler head.

Another object of the invention is to provide an assembly of this type which possesses the above advantages yet whose cost is comparable to that of conventional assemblies of this general type.

Other objects will, in part, be obvious and will, in part, appear hereinafter.

The invention accordingly comprises the features of construction, combination of elements and arrangement of parts which will be exemplified in the following detailed description, and the scope of the invention will be indicated in the claims.

Briefly, my sprinkler head assembly includes a sprinkler head coupling with an interiorly threaded axial passage, an annular shelf surrounding an end of the passage and a sleeve surrounding the shelf and extending an appreciable distance perpendicular thereto. The assembly also includes a sprinkler head having an externally threaded tubular neck that is threadedly engaged in the coupling passage. The neck has a base which defines a seat on which a movable closure member is releasably retained by a heat responsive member.

The coupling and neck are designed and dimensioned so that when the neck is threaded into the coupling passage, a dam or wall is present at the radially inner edge of the shelf that isolates the shelf from the interior of the neck and the valve member. In one invention embodiment, the dam is formed by extending the length of the sprinkler head neck. In another implementation, the dam is incorporated into the coupling. In any event, the dam prevents any pipe cement that finds its way into the coupling from running down into the sprinkler head and solidifying around the closure member which could prevent the proper operation thereof in the event of a fire.

### BRIEF DESCRIPTION OF THE DRAWINGS

For a fuller understanding of the nature and objects of the invention, reference should be made to the following detailed description taken in connection with the accompanying drawings, in which:

FIG. 1 is a diagrammatic view of a sprinkler system incorporating a conventional sprinkler head assembly, as well as an assembly embodying my invention;

FIG. 2, already described, is a sectional view taken along line 2-2 of FIG. 1, on a larger scale, showing a conventional sprinkler head assembly, and

FIG. 3 is a sectional view taken along line 3-3 of FIG. 1, on the same scale, illustrating my improved assembly.

### DETAILED DESCRIPTION OF AN ILLUSTRATIVE EMBODIMENT

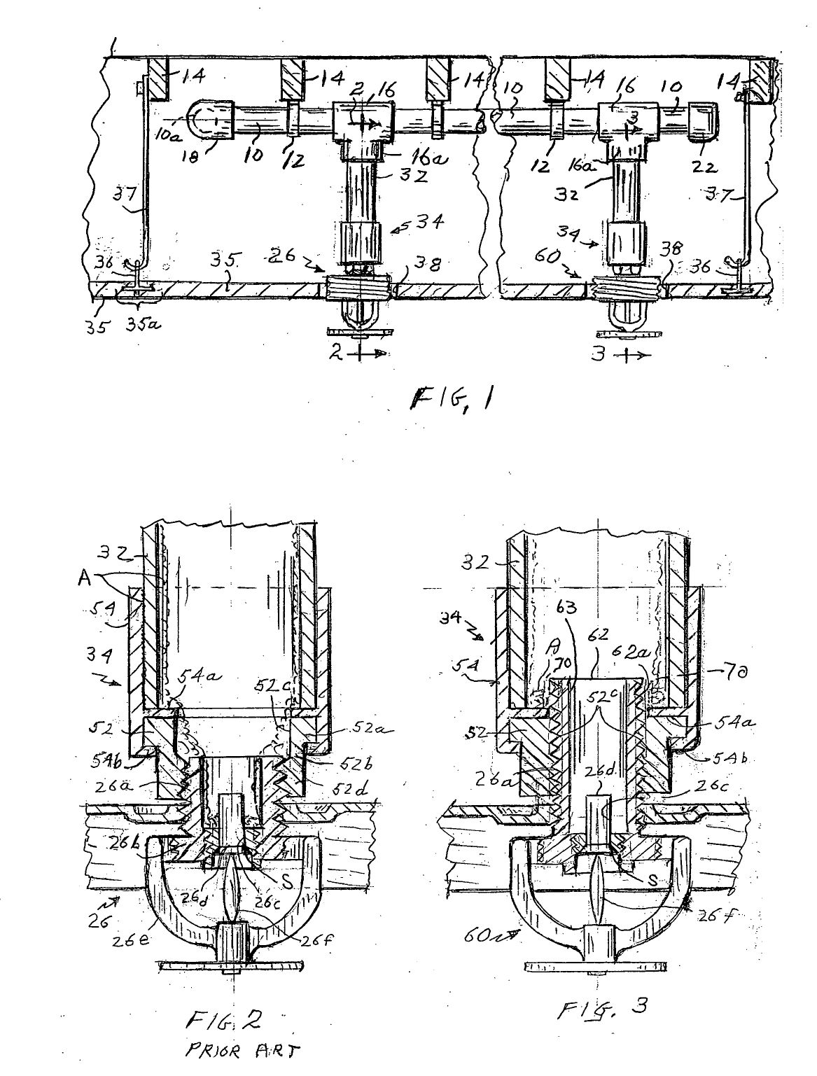

Refer now to FIG. 3 which shows a coupling 34 similar to the one in FIG. 2 but which is fitted with a special sprinkler head shown generally at 60 in FIGS. 1 and 3. Head 60 may be substantially similar to sprinkler head 26 described above except that it is provided with an unusually long exteriorly threaded tubular neck 62 having an axial passage 63. When neck 62 is screwed into coupling 34 it extends well above the bushing 52 and shelf 54a of that coupling thereby forming a dam or wall 62a at the radially inner edge of the shelf that isolates the shelf 54a from the neck passage 63 and the closure member 26d therein. Preferably, the height of the dam or wall 62a is in the range of ¼ to ½ inch. Resultantly, any pipe cement A that finds its way into coupling 34 accumulates on shelf 54a as shown in FIG. 3 rather than running down into the sprinkler head 60 as described above in connection with the FIG. 2 assembly where it could prevent the closure member or plug 26d therein from opening when ampoule 26f breaks in response to a fire.

In another assembly embodiment, the dam may be provided by an upstanding wall or collar which surrounds the bushing passage 52c as shown in phantom at 70 in FIG. 3. The wall or collar 70 may be a molded extension of shelf 54a or it may be one side of a circular trench milled in the top of bushing 52.

In any event, the inclusion of such a dam or wall in the sprinkler head assembly provides a simple solution to a serious problem which arises because some plumbers do not follow proper procedures when installing sprinkler systems. The only time a particular sprinkler head could be found to have this problem is, after the fact, when it fails to operate because its valve member 26d has been cemented closed. Discovery of this defect would become apparent occur during a forensic investigation after a fire has already occurred and caused irreparable damage in the associated building space.

The present invention takes for granted that a given sprinkler head may be installed using improper procedures and anticipates the potential problem by isolating the sprinkler head's valve member 26d from any pipe cement A that may find its way into the sprinkler head coupling 34. Moreover, it does this in a way that does not add materially to the overall cost of the sprinkler head assembly.

It will thus be seen that the objects set forth above among those made apparent from the preceding description are efficiently attained and, since certain changes may be made in the above construction without departing from the scope of the invention, it is intended that all matter contained in the above description or shown in the accompanying drawings be interpreted as illustrative, and not in a limiting sense.

It is also to be understood that the following claims are intended to cover all of the generic and specific features of the invention described herein.

What is claimed is:

1. A sprinkler head assembly comprising
a sprinkler head coupling having an interioraly threaded axial passage, an annular shelf, said shelf having an inner edge surrounding an end of said passage and a sleeve surrounding the shelf and extending an appreciable distance perpendicular thereto, and
a sprinkler head including an externally threaded tubular neck threadedly engaged in the coupling passage, said neck having a base defining an annular seat, a closure member releasably retained against said seat by a heat responsive member, the length of the neck being such that when the neck is threadedly engaged in said passage, the neck extends appreciably beyond said shelf in the same direction as the sleeve so as to form a dam at the inner edge of the shelf that isolates the shelf from the interior of the neck and the valve member.

2. The assembly defined in claim 1 wherein the coupling includes a headed bushing, and said sleeve surrounds the bushing head and includes a thin radial flange that forms said shelf.

3. The assembly defined in claim 1 wherein said neck extends from one quarter to one half inch or more beyond said shelf.

4. A sprinkler head assembly comprising
a sprinkler head coupling having an interioraly threaded axial passage, an annular shelf, said shelf having an inner edge surrounding an end of said passage and a sleeve surrounding the shelf and extending an appreciable distance perpendicular thereto, and a sprinkler head including an externally threaded tubular neck threadedly engaged in the coupling passage, said neck having a base defining an annular seat, a closure member releasably retained against said seat by a heat responsive member, said coupling and neck being designed and dimensioned so that when the neck is threadedly engaged in the coupling passage, a dam is present at the inner edge of the shelf which isolates the shelf from the interior of the neck and the valve member.

5. The assembly defined in claim 4 wherein the dam is constituted by an extension of said neck.

6. The assembly in claim 4 wherein the dam is constituted by a wall at said inner edge of the shelf that extends in the same direction as the sleeve.
